(19) United States
(12) Patent Application Publication
(10) Pub. No.: US 2026/0268145 A1
(43) Pub. Date: Sep. 10, 2026

(54) METHOD, APPARATUS, DEVICE AND STORAGE MEDIUM FOR DATA PROCESSING

(71) Applicant: Beijing Zitiao Network Technology Co., Ltd., Beijing (CN)

(72) Inventors: Songwei Liu, Beijing (CN); Fangmin Chen, Beijing (CN)

(21) Appl. No.: 19/544,937

(22) Filed: Feb. 19, 2026

(30) Foreign Application Priority Data
Mar. 5, 2025 (CN) 202510256879.4

(51) Int. Cl. G06N 3/082

(52) U.S. Cl. CPC G06N 3/082

(57) ABSTRACT

The disclosure provides a method, an apparatus, a device, and a storage medium for data processing. An example method includes: generating, by executing a machine learning model, a first model output in a first processing step of a plurality of processing steps based on a first model input of the first processing step, the execution of the machine learning model including an adjustment to the machine learning model; determining an error compensation value for the first processing step based on single-step error information and transformation information, the single-step error information being related to an error caused by the adjustment in a single processing step, the transformation information controlling a degree of data change between adjacent processing steps of the plurality of processing steps; and determining a second model input for a second processing step of the plurality of processing steps.

### CROSS-REFERENCE

The present application claims the priority of Chinese Patent Application No. 202510256879.4, filed on Mar. 5, 2025, and entitled “Method, Apparatus, Device and Storage Medium for Data Processing”, which is incorporated herein by reference in its entirety.

### TECHNICAL FIELD

Example embodiments of the present disclosure generally relate to the field of computers, and in particular, to a method, an apparatus, a device, and a computer-readable storage medium for data processing.

### BACKGROUND

In recent years, machine learning models have been rapidly developed and widely used in various technical fields (for example, robot control field or image processing field). To ensure that outputs of a machine learning model may meet users' requirements, a trained machine learning model needs to be deployed to process input data. However, during a model deployment process, the machine learning model may need to be adjusted to achieve efficient model deployment. Such adjustment may affect the performance of the machine learning model.

### SUMMARY

In a first aspect of the present disclosure, a data processing method is provided. The method includes: generating, by executing a machine learning model, a first model output in a first processing step of a plurality of processing steps based on a first model input of the first processing step, the plurality of processing steps being configured to obtain a target output from an initial input using the machine learning model, the execution of the machine learning model including an adjustment to the machine learning model; determining an error compensation value for the first processing step based on single-step error information and transformation information, the single-step error information being related to an error caused by the adjustment in a single processing step, the transformation information controlling a degree of data change between adjacent processing steps of the plurality of processing steps; and determining a second model input for a second processing step of the plurality of processing steps based on the first model input, the first model output, and the error compensation value.

In a second aspect of the present disclosure, an apparatus for data processing is provided. The apparatus includes: a generation module configured to generate, by executing a machine learning model, a first model output in a first processing step of a plurality of processing steps based on a first model input of the first processing step, the plurality of processing steps being configured to obtain a target output from an initial input using the machine learning model, the execution of the machine learning model including an adjustment to the machine learning model; a first determination module configured to determine an error compensation value for the first processing step based on single-step error information and transformation information, the single-step error information being related to an error caused by the adjustment in a single processing step, the transformation information controlling a degree of data change between adjacent processing steps of the plurality of processing steps; and a second determination module configured to determine a second model input for a second processing step of the plurality of processing steps based on the first model input, the first model output, and the error compensation value.

In a third aspect of the present disclosure, an electronic device is provided. The device includes at least one processor; and at least one memory, the at least one memory being coupled to the at least one processor and storing instructions executable by the at least one processor, the instructions, when executed by the at least one processor, causing the device to perform the method of the first aspect.

In a fourth aspect of the present disclosure, a computer-readable storage medium is provided. The computer-readable storage medium has a computer program stored thereon, the computer program being executable by a processor to implement the method of the first aspect.

In a fifth aspect of the present disclosure, a computer program product is provided. The product includes a computer program, where the computer program, when executed by a processor, implements the method of the first aspect.

It may be understood that the content described in this Summary section is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The foregoing and other features, advantages, and aspects of the embodiments of the present disclosure become more apparent with reference to the following detailed description and in conjunction with the drawings. In the drawings, the same or similar reference numerals denote the same or similar elements.

FIG. 1 illustrates a schematic diagram of an example environment in which the embodiments according to the present disclosure may be implemented;

FIG. 2 illustrates an example architectural diagram of a data processing system according to some embodiments of the present disclosure;

FIG. 3 illustrates a schematic diagram of a diffusion model processing flow according to some embodiments of the present disclosure;

FIG. 4 illustrates a flowchart of an example process of data processing according to some embodiments of the present disclosure;

FIG. 5 illustrates a schematic structural block diagram of an example apparatus for data processing according to some embodiments of the present disclosure; and

FIG. 6 illustrates a block diagram of an electronic device capable of implementing a plurality of embodiments of the present disclosure.

### DETAILED DESCRIPTION OF EMBODIMENTS

The embodiments of the present disclosure are described in more detail below with reference to the drawings. Although some embodiments of the present disclosure are shown in the drawings, it would be appreciated that the present disclosure may be implemented in various forms and should not be construed as limited to the embodiments set forth herein. Instead, these embodiments are provided for a more thorough and complete understanding of the present disclosure. It may be understood that the drawings and embodiments of the present disclosure are only for illustrative purposes and are not intended to limit the protection scope of the present disclosure.

In the description of the embodiments of the present disclosure, the term “include/comprise” and similar terms thereof are understood as open-ended inclusions, that is, “include/comprise but not limited to”. The term “based on” is understood as “at least partially based on”. The term “an embodiment” or “the embodiment” is understood as “at least one embodiment”. The term “some embodiments” is understood as “at least some embodiments”. Other explicit and implicit definitions may be included below.

Herein, unless otherwise specified, “executing a step in response to A” does not mean that the step is executed immediately after “A”, but may include one or more intermediate steps.

It may be understood that the data involved in the technical solution (including but not limited to the data itself, acquisition, use, storage or deletion of the data) should comply with the requirements of corresponding laws, regulations and related provisions.

It may be understood that before using the technical solution disclosed in the embodiments of the present disclosure, the user should be informed of the type, scope of use, use scenario, etc. of the personal information involved in the present disclosure in an appropriate manner and obtain the user's authorization in accordance with relevant laws and regulations.

For example, in response to receiving the user's active request, the user may be sent a prompt message to clearly prompt the user that the requested operation will require the acquisition and use of the user's personal information, so that the user may independently choose whether to provide the personal information to software or hardware, such as electronic devices, applications, servers, or storage media, that perform the operations of the technical solution of the present disclosure according to the prompt information.

As an optional but non-restrictive implementation, in response to receiving the user's active request, the user may be sent a prompt message in the form of a pop-up window, for example, and the prompt message may be presented in the pop-up window in text. In addition, the pop-up window may also carry a selection control for the user to select “agree” or “disagree” to provide personal information to the electronic device.

It may be understood that the above process of notifying and obtaining user authorization is only illustrative and does not limit the implementation of the present disclosure, and other methods that meet relevant laws and regulations may also be applied to the implementation of the present disclosure.

As used herein, the term “model” may learn the correlation between the corresponding input and output from the training data, so that the corresponding output may be generated for a given input after the training is completed. The generation of the model may be based on machine learning techniques. Deep learning is a machine learning algorithm that processes input and provides corresponding output by using multi-layer processing units. Herein, the “model” may also be referred to as a “machine learning model”, a “machine learning network” or a “network”, and these terms are used interchangeably herein. A model may include different types of processing units or networks.

As used herein, the “unit”, “operation unit” or “subunit” may be composed of a machine learning model or network of any suitable structure. As used herein, a set of elements or similar expressions may include one or more such elements. For example, a “set of convolution units” may include one or more convolution units.

### Example Environment

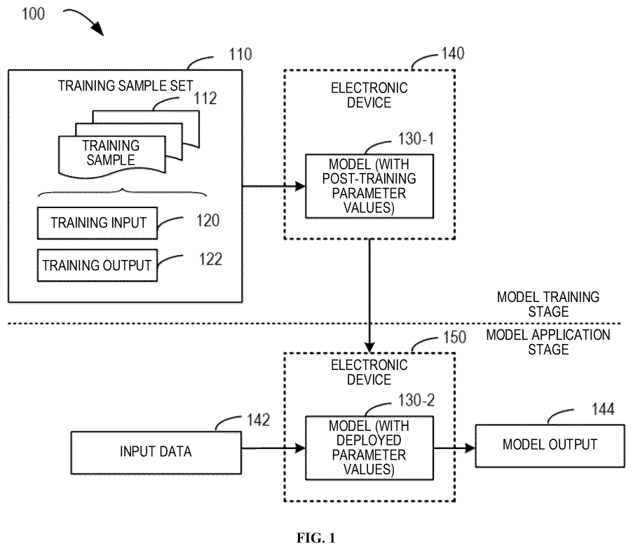

FIG. 1 illustrates a schematic diagram of an example environment 100 in which the embodiments of the present disclosure may be implemented. As shown in FIG. 1, a model 130-1 with pre-training parameter values and a model 130-2 with post-training parameter values may be collectively or individually referred to as a model 130. The model 130 may be included in an electronic device 140 and/or an electronic device 150.

In the environment 100 shown in FIG. 1, it is desired to train and use a machine learning model (that is, the model 130) that is configured for various application environments. For example, if the model is an image processing model, the image processing model may be used to process a noisy image input by a user to obtain a clear noise-free image. For another example, if the model is an image generation model, the image generation model may be used to generate an image corresponding to a text input by a user according to the text.

As shown in FIG. 1, the environment 100 includes the electronic device 140 and the electronic device 150. A model training system may exist in the electronic device 140, and a model application system may exist in the electronic device 150. The upper portion of FIG. 1 illustrates the process of a model training stage, and the lower portion illustrates the process of a model application stage. Before training, the parameter values of the model 130 may have initial values or may have pre-trained parameter values obtained through a pre-training process. The model may be trained via forward propagation and reverse propagation to update and adjust the parameter values of the model, thereby obtaining the model 130-1 with post-training parameter values. The training of the model may include pre-training and fine-tuning. Based on the updated parameter values, the model 130-2 may be used, in the model application stage, to implement an image processing task, such as an image denoising task.

In the model training stage, the model 130 may be trained using the electronic device 140 based on a training sample set 110 including a plurality of training samples. Here, each training sample 112 may involve a binary group format. For example, for an image generation task, the training sample 112 may include a training input 120 and a training output in the image generation task. The training input in the image generation task may include, for example, a training text and an image corresponding to the training text. The training sample 112 including a model input 120 and a model output 122 may be used to train the model 130. Specifically, a large number of training samples may be used to iteratively perform the training process. After the training is completed, the model 130 may include knowledge about the image generation task.

In the model application stage, the trained model 130-1 may be deployed at the electronic device 150, and the electronic device 150 may be used to process input data. In the model deployment process, in order to make the model adaptable to the electronic device 150, the parameters (such as parameter values or parameter accuracy) of the model 130-1 need to be adjusted to obtain the model 130-2 with deployed parameter values. For example, the weight or activation value of the model 130-1 may be converted from high precision (for example, 32-bit floating point number) to low precision (for example, 8-bit or 4-bit integer). After the deployment is completed, the model 130-2 may be used to process the input data 142 to obtain a model output 144. For example, the electronic device 150 may be used to perform an image processing task (such as image denoising) or an image generation task.

In FIG. 1, the electronic device 140 and the electronic device 150 may include any computing system with computing power, such as various computing devices/systems, terminal devices, servers, etc. The terminal device may be any type of mobile terminal, fixed terminal or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/video camera, a positioning device, a television receiver, a radio broadcast receiver, an e-book device, a game device, or any combination thereof, including accessories and peripherals of these devices or any combination thereof. In some embodiments, the electronic device 150 may also support any type of user-specific interface (such as “wearable” circuitry, etc.).

It may be understood that the components and arrangements in the environment 100 shown in FIG. 1 are only examples, and the computing system suitable for implementing the example implementations described in the present disclosure may include one or more different components, other components, and/or different arrangements. The implementations of the present disclosure are not limited in this regard. The embodiments of the present disclosure mainly relate to the training stage of the image generation model.

As briefly mentioned above, in the process of deploying a trained machine learning model, the parameters (for example, weights) of the machine learning model need to be adjusted to adapt to the data distribution in an actual application scenario, improve the operation speed of the model, and achieve efficient deployment of the model. However, the adjustment of the model parameters during the deployment process often leads to errors in the deployed machine learning model, affecting the performance of the machine learning model.

The embodiments of the present disclosure provide a solution for data processing. The solution includes: generating, by executing a machine learning model, a first model output in a first processing step of a plurality of processing steps based on a first model input of the first processing step, the plurality of processing steps being configured to obtain a target output from an initial input using the machine learning model, the execution of the machine learning model including an adjustment to the machine learning model; determining an error compensation value for the first processing step based on single-step error information and transformation information, the single-step error information being related to an error caused by the adjustment in a single processing step, the transformation information controlling a degree of data change between adjacent processing steps of the plurality of processing steps; and determining a second model input for a second processing step of the plurality of processing steps based on the first model input, the first model output, and the error compensation value.

In this way, the embodiments of the present disclosure are able to determine the error compensation value corresponding to the single processing step based on the single-step error information caused by the adjustment in the single processing step and the degree of data change between adjacent steps in the process of implementing the plurality of processing steps using the adjusted machine learning model. In this way, the error caused by the adjustment to the machine learning model is compensated. This advantageously reduces the impact of the error generated in the machine learning model deployment process on the performance of the machine learning model, thereby improving the accuracy of inference using the machine learning model.

Various example implementations of the solution will be described in detail below with further reference to the drawings.

### Example Process

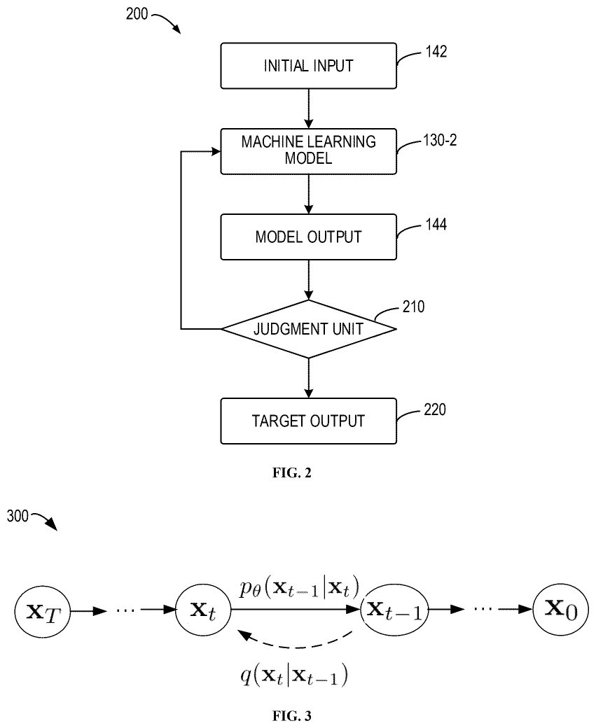

FIG. 2 illustrates an example architectural diagram of a data processing system 200 according to some embodiments of the present disclosure. As shown in FIG. 2, the data processing system 200 may be implemented or included in the electronic device 150.

The electronic device 150 provides input data 142 to the machine learning model, and the machine learning model 130-2 is used to process the input data 142. In some embodiments, the input data 142 may include a noise sample, a text description, an image material, or the like. For example, the input data 142 may be an image material including noise, and the machine learning model 130-2 is used to process the image material.

In some embodiments, the electronic device 150 may perform a data processing task including a plurality of rounds (that is, a plurality of processing steps) by using the adjusted machine learning model. For example, in the case of using the machine learning model to perform the processing step of the first round, the initial input (that is, the input data 142) is provided to the machine learning model to obtain the output of the machine learning model. Subsequently, the output of the machine learning model is used as the input of the next round. In the next round, the output of the machine learning model in the previous round is provided to the machine learning model to obtain the output of the machine learning model in this round. The above steps are repeated, and the output of the machine learning model in the final round is used as the target output of the data processing task. In some embodiments, the adjustment to the machine learning model may include the adjustment of the parameters of the machine learning model, such as the pruning of model weights or the quantization of model weights. The adjustment to the machine learning model may introduce errors. For example, the quantization of model weights may introduce quantization errors. In the following description, the quantization error will be mainly used as an example, but it would be appreciated that the errors caused by other types of adjustments are similar. In some embodiments, the model input may be an image to be processed (that is, the initial input) including noise information or a noise signal generated in the previous generation step, and the model output may be a noise signal or a denoised image (that is, the target output).

In some embodiments, the machine learning model 130-2 may be a diffusion model or a flow matching model. FIG. 3 illustrates a schematic diagram of a diffusion model processing flow 300 according to some embodiments of the present disclosure. As shown in FIG. 3, the forward diffusion process is from right to left (x₀→x_{T}), and random noise is continuously added at each iteration step t=1, 2, . . . , T (where T is an integer greater than or equal to 1) to destroy the initial data. Each step in the forward process is a Gaussian transition q(xₜ+|xₜ₋₁)=N(\sqrt{1−βₜ}+ₜ₋₁, β+βₜI), where

$${\{ {β}_{t} \}}_{t = 0}^{T}$$

is usually a predefined variance value. Therefore, the intermediate output (also referred to as a hidden code or a hidden variable) xₜ obtained at each iteration step t may be expressed as:

$${x}_{t} = \sqrt{{α}_{t}} {x}_{0} + \sqrt{1 - {α}_{t}} ω , ω ∼ N ( 0 , I ) \qquad ( 1 )$$

where

$${α}_{t} = {\prod }_{s = 1}^{t} ( 1 - {β}_{s} ) .$$

When T is large enough. αₜ is close to 0, and the final output x_{T} is close to an isotropic Gaussian distribution, xₜ₋₁ represents the model output corresponding to the time step t−1, and xₜ represents the model output corresponding to the time step t.

In FIG. 3, the reverse diffusion process is from left to right (x_{T}→x₀), and noise is continuously removed at each iteration step. Each step q(xₜ₋₁|xₜ) of the reverse diffusion process may be another Gaussian transition p_{θ}(xₜ₋₁|xₜ)=N(xₜ₋₁;μ_{θ}(xₜ, t), σ_{θ}(xₜ, t)I), where μ_{θ}(xₜ, t) may be decomposed into a linear combination of xₜ and a noise approximation model ∈_{θ}(xₜ, t), and σ_{θ}(xₜ, t) is a noise variance value. The noise approximation model ∈_{θ}(xₜ, t) may be obtained by solving the following optimization problem:

$${min}_{θ} {E}_{{x}_{0} \sim q ( {x}_{0} ) , ω \sim N ( 0 , I ) , t} {‖ {ϵ}_{θ} ( {x}_{t} , t ) - ω ‖}_{2}^{2} \qquad ( 2 )$$

In some implementations, σ_{θ}(xₜ, t) in the diffusion model may be unchanged. In other implementations, σ_{θ}(xₜ, t) may be learned through a neural network, which may obtain better data generation effects. The learning objective of σ_{θ}(xₜ, t) may be to achieve better interpolation between the upper and lower thresholds of the fixed covariance.

In the inference stage of generating desired data, the following reverse diffusion process may be used to sample the data to be generated:

$${x}_{t - 1} = \frac{1}{\sqrt{1 - {β}_{f}}} ( {x}_{t} - \frac{{β}_{t}}{\sqrt{1 - {α}_{t}}} {ϵ}_{θ} ( {x}_{t} , t ) ) + {σ}_{t} z \qquad ( 3 )$$

where z~N(0,I) is randomly sampled noise, and σₜ represents a noise variance value. That is, the diffusion model for data generation may use the randomly sampled noise z~N(0, I) as input and generate desired data, that is, x₀, through T iterations.

The above briefly introduces the principle of the diffusion model. In some embodiments, the diffusion model may be used to process the initial input to obtain the target output. For example, the diffusion model may be used to denoise the input image.

For a certain processing step (for example, the first processing step) of the plurality of processing steps of the data processing task, a first model input (for example, the initial input 142 of the data processing task or the model output of the previous processing step of the first processing step) of the first processing step is provided to the machine learning model 130-2. Subsequently, the first processing step is performed using the machine learning model 130-2 to generate the first model output.

In some embodiments, the single-step error information corresponding to a processing step may be determined based on the error caused by the applied adjustment in the processing step. Subsequently, the error compensation value for the first processing step is determined based on the single-step error information and the transformation information. The transformation information is used to control the degree of data change between adjacent processing steps of the plurality of processing steps. In some embodiments, the error compensation value may be used to compensate for the error caused by the adjustment to the machine learning model.

In the case where the machine learning model 130-2 is a denoising diffusion implicit model, the machine learning model 130-2 may be used to perform denoising processing on the input image. The deterministic sampling process of the denoising diffusion implicit model may be expressed by the following formula:

$${x}_{t - 1} = \sqrt{{α}_{t - 1}} ( \frac{{x}_{t} - \sqrt{1 - {α}_{t}} {ϵ}_{θ} ( {x}_{t} , t )}{\sqrt{{α}_{t - 1}}} ) + \sqrt{1 - {α}_{t - 1}} {ϵ}_{θ} ( {x}_{t} , t ) \qquad ( 4 )$$

where xₜ₋₁ is the output image of the processing step corresponding to the t−1 time step, xₜ is the output image of the processing step corresponding to the t time step, αₜ₋₁ is the transformation information of the processing step corresponding to the t−1 time step, αₜ is the transformation information of the processing step corresponding to the t time step, and ∈_{θ}(xₜ, t) is the model output of the machine learning model 130-2 corresponding to the t−1 time step.

After simplification, the formula (4) is:

$${x}_{t - 1} = \frac{\sqrt{{α}_{t - 1}}}{\sqrt{{α}_{t}}} {x}_{t} + ( \sqrt{1 - {α}_{t - 1}} - \frac{\sqrt{{α}_{t - 1} ( 1 - {α}_{t} )}}{\sqrt{{α}_{t}}} ) {ϵ}_{θ} ( {x}_{t} , t ) \qquad ( 5 )$$

It is assumed that a quantization error is introduced in the model output ∈_{θ}(xₜ, t) of each step, and the actual model output is

$${\tilde{ϵ}}_{θ} ( {x}_{t} , t ) = {ϵ}_{θ} ( {x}_{t} , t ) + {ε}_{t} \qquad ( 6 )$$

where \tilde{∈}_{θ}(xₜ, t) is the actual model output corresponding to the t time step after the quantization error is introduced, ∈_{θ}(xₜ, t) is the predicted model output corresponding to the t time step in the case where no quantization error is introduced, and εₜ is the quantization additive noise, indicating the single-step error information of the processing step corresponding to the time step t.

Substituting the formula (6) into the formula (5), it may be determined that the actual sampling process of the machine learning model 130-2 may be expressed by the following formula:

$${\tilde{x}}_{t - 1} = \frac{\sqrt{{α}_{t - 1}}}{\sqrt{{α}_{t}}} {\tilde{x}}_{t} + ( \sqrt{1 - {α}_{t - 1}} - \frac{\sqrt{{α}_{t - 1} ( 1 - {α}_{t} )}}{\sqrt{{α}_{t}}} ) {ϵ}_{θ} ( {\tilde{x}}_{t} , t ) + {ε}_{t} \qquad ( 7 )$$

where \tilde{x}ₜ₋₁ is the output image of the processing step corresponding to the t−1 time step after the quantization error is introduced, and \tilde{x}ₜ is the output image of the processing step corresponding to the t time step after the quantization error is introduced. \tilde{x}ₜ may be expressed by the following formula:

$${\tilde{x}}_{t} = {x}_{t} + {δ}_{t} \qquad ( 8 )$$

where δₜ is the cumulative error from the processing step corresponding to the initial time step to the processing step corresponding to the t time step.

The following formula may be obtained according to the formula (7) and the formula (8):

$${x}_{t - 1} + {δ}_{t - 1} = \frac{\sqrt{{α}_{t - 1}}}{\sqrt{{α}_{t - 1}}} {\tilde{x}}_{t} + ( \sqrt{1 - {α}_{t - 1}} - \frac{\sqrt{{α}_{t - 1} ( 1 - {α}_{t} )}}{\sqrt{{α}_{t}}} ) ( {ϵ}_{θ} ( {x}_{t} + {δ}_{t} , t ) + {ε}_{t} \qquad ( 9 )$$

where δₜ₋₁ is the cumulative error from the processing step corresponding to the initial time step to the processing step corresponding to the t−1 time step.

Subsequently, a first-order Taylor expansion is performed on ∈_{θ}(xₜ+δₜ, t) in the formula (9) to obtain the following formula:

$${ϵ}_{θ} ( {x}_{t} + {δ}_{t} , t ) \approx {ϵ}_{θ} ( {x}_{t} , t ) + {J}_{t} {δ}_{t} \qquad ( 10 )$$

where Jₜ=∇ₓ_{ₜ}∈_{θ}(xₜ, t) is the Jacobian matrix of the machine learning model 130-2.

Since the error is gradually accumulated during the execution of the data processing task, in some embodiments, the error compensation value may be determined based on a plurality of pieces of single-step error information corresponding to a plurality of previous processing steps of the first processing step. The following error propagation equation may be determined according to the formula (9) and the formula (10):

$${δ}_{t - 1} = [ \frac{\sqrt{{α}_{t - 1}}}{\sqrt{{α}_{t}}} I + ( \sqrt{1 - {α}_{t - 1}} - \frac{\sqrt{{a}_{t - 1} ( 1 - {α}_{t} )}}{\sqrt{{a}_{t}}} ) {J}_{t} ] {δ}_{t} + ( \sqrt{1 - {α}_{t - 1}} - \frac{\sqrt{{a}_{t - 1} ( 1 - {α}_{t} )}}{\sqrt{{α}_{t}}} ) {ε}_{t} \qquad ( 11 )$$

Since the transformation information αₜ₋₁ and αₜ are determinable values, the error propagation equation (11) may be simplified to
where

$${δ}_{t - 1} = {A}_{t} {δ}_{t} + {B}_{t} {ε}_{t} \qquad ( 12 )$$

$${A}_{t} = [ \frac{\sqrt{{α}_{t - 1}}}{\sqrt{{α}_{t}}} I + ( \sqrt{1 - {α}_{t - 1}} - \frac{\sqrt{{α}_{t - 1} ( 1 - {α}_{t} )}}{\sqrt{{α}_{t}}} ) {J}_{t} ] ,$$

$${B}_{t} = ( \sqrt{1 - {α}_{t - 1}} - \frac{\sqrt{{α}_{t - 1} ( 1 - {α}_{t} )}}{\sqrt{{α}_{t}}} ) .$$

The formula (12) is recursively expanded in the order from the t=T time step to the t=1 time step to obtain the closed-form solution of the cumulative error of the initial processing step (the t=1 time step):

$${δ}_{0} = {\sum }_{t = 1}^{T} ( {\prod }_{k = 1}^{t - 1} {A}_{k} ) {B}_{t} {ε}_{t} \qquad ( 13 )$$

where δ₀ represents the cumulative error corresponding to the initial processing step.

In summary, after the quantization error is introduced into the model, the cumulative error will be generated by calling the machine learning model 130-2 multiple times. In order to offset this cumulative error, a correction term Δt may be introduced into the sampling formula (5) to obtain the following sampling formula:

$${x}_{t - 1} = \frac{\sqrt{{α}_{t - 1}}}{\sqrt{{α}_{t}}} {x}_{t} + ( \sqrt{1 - {α}_{t - 1}} - \frac{\sqrt{{α}_{t - 1} ( 1 - {α}_{t} )}}{\sqrt{{α}_{t}}} ) {ϵ}_{θ} ( {x}_{t} , t ) + {Δ}_{t} \qquad ( 14 )$$

In order to eliminate the cumulative error δₜ, it is necessary to ensure that Δₜ=δₜ. The calculation formula of the correction term Δₜ may be determined by matrix inverse operation:

$${Δ}_{t} = - {\sum }_{k = t}^{T} ( {\prod }_{j = t}^{k - 1} {A}_{j}^{- 1} ) {B}_{k} {ε}_{k} \qquad ( 15 )$$

where the propagation matrix is

$${A}_{j} = \frac{\sqrt{{α}_{t - 1}}}{\sqrt{{α}_{t}}} I + {B}_{j} {J}_{j} .$$

As shown in the formula (15), in some embodiments, a plurality of transformation information items corresponding to a plurality of previous processing steps of the second processing step, respectively, may be determined based on the transformation information. The transformation information may include a plurality of transformation information items corresponding to a certain processing step. For example, in the formula (15), the transformation information of the processing step corresponding to the t time step includes a plurality of transformation information items such as Aₜ₋₁, Aₜ, and Aₜ₊₁. A plurality of single-step error items corresponding to the plurality of previous processing steps, respectively, are determined based on the single-step error information. The single-step error item represents the single-step error information corresponding to a certain processing step. For example, the formula (15) includes a plurality of single-step error items such as Bₜεₜ, Bₜ₊₁εₜ₊₁, and Bₜ₊₂εₜ₊₂. The error compensation value is determined based on the plurality of transformation information items and the plurality of single-step error items.

In some embodiments, the plurality of previous processing steps of the second processing step includes the first processing step and a plurality of previous steps of the first processing step. In some embodiments, the first processing step and the second processing step may correspond to adjacent time steps. For example, the first processing step corresponds to the tth time step, and the second processing step corresponds to the t−1th time step. In some embodiments, the first processing step and the second processing step may correspond to nonadjacent time steps. For example, the first processing step corresponds to the tth time step, and the second processing step corresponds to the t−5th time step. A plurality of original processing steps may be sampled to determine the plurality of processing steps. In this case, the first processing step and the second processing step are adjacent in the sequence of the plurality of sampled steps.

Based on the formula (15), it may be determined that the coefficient of the correction term Δₜ increases with the increase of T, which indicates that the error in the first few steps has the greatest impact on the output of the machine learning model. In some embodiments, since the machine learning model 130-2 is not sensitive to the local change of the model input, it may be assumed that Jₜ=0, thereby ignoring the Jacobian term. In addition, the propagation matrix Δⱼ may be degenerated into a scalar coefficient:

$${A}_{j} = \frac{\sqrt{{α}_{t - 1}}}{\sqrt{{α}_{t}}} I \to {A}_{j}^{- 1} \frac{\sqrt{{α}_{t}}}{\sqrt{{α}_{t - 1}}} I \qquad ( 16 )$$

Subsequently, the continued product term in the formula (12) is expanded:

$${\prod }_{j = t}^{k - 1} {A}_{j}^{- 1} = {\prod }_{j = t}^{k - 1} \frac{\sqrt{{α}_{j}}}{\sqrt{{α}_{j - 1}}} = \frac{\sqrt{{α}_{t}}}{\sqrt{{α}_{t - 1}}} \cdot \frac{\sqrt{{α}_{t + 1}}}{\sqrt{{α}_{t}}} … … = \frac{\sqrt{{α}_{k - 1}}}{\sqrt{{α}_{t - 1}}} \qquad ( 17 )$$

Substituting the continued product result (17) into the formula (15), the following formula may be obtained:

$${Δ}_{t} = - {\sum }_{k = t}^{T} ( \frac{\sqrt{{α}_{k - 1}}}{\sqrt{{α}_{t - 1}}} ) {B}_{k} {ε}_{k} \qquad ( 18 )$$

After extracting the common factor

$$\frac{1}{\sqrt{{α}_{t - 1}}} ,$$

the following formula may be obtained:

$${Δ}_{t} = - \frac{1}{\sqrt{{α}_{t - 1}}} {\sum }_{k = t}^{T} \sqrt{{α}_{k - 1}} {B}_{k} {ε}_{k} \qquad ( 19 )$$

where

$$\frac{1}{\sqrt{{α}_{t - 1}}}$$

is a scaling factor, and \sqrt{αₖ₋₁}Bₖ a weight coefficient.

As shown in the formula (19), in some embodiments, for the first processing step of the plurality of processing steps, it may first be based on the transformation information item corresponding to the first processing step in the transformation information. Subsequently, the scaling factor corresponding to the first processing step is determined based on the plurality of transformation information items. A plurality of weight coefficients are determined based on the plurality of transformation information items. The plurality of weight coefficients respectively indicates the influence degrees of the corresponding processing steps of the plurality of previous processing steps on the second processing step. For example, the weight coefficients in the formula (19) include the weight coefficient \sqrt{αₜ₋₁}Bₜ corresponding to the processing step of the t time step, the weight coefficient \sqrt{αₜ}Bₜ₊₁ corresponding to the processing step of the t+1 time step, the weight coefficient \sqrt{aₜ₊₁}Bₜ₊₂ corresponding to the processing step of the t+2 time step, and the like. Subsequently, the cumulative error value corresponding to the first processing step is determined based on the plurality of weight coefficients and a plurality of single-step error items corresponding to the plurality of previous processing steps, respectively. For example, the product of the weight coefficient corresponding to a certain processing step and the single-step error item corresponding to the processing step may be determined as the quantization error value corresponding to the processing step. The sum of the quantization errors corresponding to the plurality of processing steps is used as the cumulative error value corresponding to the step. The error compensation value corresponding to a certain step is determined based on the cumulative error value corresponding to the step and the scaling factor corresponding to the step.

In some embodiments, the plurality of single-step error items corresponding to the plurality of previous processing steps, respectively, may be determined based on the single-step error information. For a certain processing step of the plurality of processing steps, among the previous processing steps of the processing step, several previous processing steps adjacent to the step have the greatest influence on the processing step. Therefore, in some embodiments, for a certain processing step, the error compensation value corresponding to the processing step may be determined only based on the previous processing step adjacent to the processing step. In this way, the solving process of the error compensation value may be further simplified. For example, the error compensation value may be determined based on the previous three processing steps.

$${Δ}_{t} \approx - \frac{1}{\sqrt{{α}_{t - 1}}} {\sum }_{k = t}^{min ( t + 3 , T )} \sqrt{{α}_{k - 1}} {B}_{k} {ε}_{k} \qquad ( 20 )$$

Substituting the formula (20) into the formula (14), the following formula may be obtained:

$${x}_{t - 1} = \frac{\sqrt{{a}_{{α}_{t - 1}}}}{\sqrt{{α}_{t}}} {x}_{t} + ( \sqrt{1 - {α}_{t - 1}} - \frac{\sqrt{{α}_{t - 1} ( 1 - {α}_{t} )}}{\sqrt{{α}_{t}}} ) {ϵ}_{θ} ( {x}_{t} , t ) - \frac{1}{\sqrt{{α}_{t - 1}}} {\sum }_{k = t}^{min ( t + 3 , T )} \sqrt{{α}_{k - 1}} {B}_{k} {ε}_{k} \qquad ( 21 )$$

The error compensation value has an inhibitory effect on the upper bound of the error generated by the machine learning model 130-2. Based on this, the unknown term in the formula (21) may be inferred. First, the approximation of the single-step error information ensures that it is bounded, that is, there is a constant σ>0, so that there is a k value that makes ∥εₖ∥≤σ. In addition, the gradient of the trained machine learning model 130-2 converges, so there is a constant L, so that there is a value that makes ∥Jₜ∥≤L. At the same time, only the influence of several adjacent previous processing steps (for example, the previous three previous processing steps) on the error compensation value is considered. With the change of the time step, the conversion information monotonically decreases from the t=T time step to the t=1 time step. The above are the known conditions and assumed conditions for solving the error compensation value.

In some embodiments, the correction term is introduced into the error propagation equation (12), and the following formula may be obtained:

$${δ}_{t - 1} = {A}_{t} {δ}_{t} + {B}_{t} {ε}_{t} + {Δ}_{t} \qquad ( 22 )$$

$${δ}_{t - 1} = {A}_{t} {δ}_{t} + {B}_{t} {ε}_{t} - \frac{1}{\sqrt{{α}_{t - 1}}} {\sum }_{k = t}^{min ( t + m , T )} \sqrt{{α}_{k - 1}} {B}_{k} {ε}_{k} \qquad ( 23 )$$

Expanding the continuous summation in the formula (23), the following formula may be obtained:

$${δ}_{t - 1} = {A}_{t} {δ}_{t} + {B}_{t} {ε}_{t} - \frac{\sqrt{{α}_{t - 1}}}{\sqrt{{α}_{t - 1}}} {B}_{t} {ε}_{t} - \frac{1}{\sqrt{{α}_{t - 1}}} {\sum }_{k = t + 1}^{min ( t + m , T )} \sqrt{{α}_{k - 1}} {B}_{k} {ε}_{k} \qquad ( 24 )$$

Eliminating the noise term in the formula (24), the following formula may be obtained:

$${δ}_{t - 1} = {A}_{t} {δ}_{t} - \frac{1}{\sqrt{{α}_{t - 1}}} {\sum }_{k = t + 1}^{min ( t + m , T )} \sqrt{{α}_{k - 1}} {B}_{k} {ε}_{k} \qquad ( 25 )$$

Subsequently, the upper bound of the norm of the error propagation coefficient matrix Aₜ is analyzed. The propagation coefficient is:

$${A}_{t} = \frac{\sqrt{{α}_{t - 1}}}{\sqrt{{α}_{t}}} I + {B}_{t} {J}_{t} \qquad ( 26 )$$

The upper bound of the norm of the propagation officiant is:

$$‖ {A}_{t} ‖ \leq \frac{\sqrt{{α}_{t - 1}}}{\sqrt{{α}_{t}}} + ‖ {B}_{t} ‖ L \qquad ( 27 )$$

Based on the above known conditions, it is known that since and

$$\frac{\sqrt{{α}_{t - 1}}}{\sqrt{{α}_{t}}} < 1$$

∥Bₜ∥L are small quantities, there is ρₜ<1 to cause

$$‖ {A}_{t} ‖ \leq {ρ}_{t} \qquad ( 28 )$$

After substituting the formula (27) into the error propagation equation (25) and solving the upper bound of the norm of the formula (25), it is known that the following formula holds:

$$‖ {δ}_{t - 1} ‖ \leq {ρ}_{t} ‖ {δ}_{t} ‖ + \frac{1}{\sqrt{{α}_{t - 1}}} {\sum }_{k = t + 1}^{min ( t + m , T )} \sqrt{{α}_{k - 1}} ‖ {B}_{k} ‖ σ \qquad ( 29 )$$

The corrected noise residual term is defined as

$${η}_{t} = \frac{1}{\sqrt{{α}_{t - 1}}} {\sum }_{k = t + 1}^{min ( t + m , T )} \sqrt{{α}_{k - 1}} ‖ {B}_{k} ‖ σ \qquad ( 30 )$$

where ηₜ is the corrected noise residual term.

At this time, the upper bound of the cumulative error may be expressed as

$$‖ {δ}_{t - 1} ‖ \leq {ρ}_{t} ‖ {δ}_{t} ‖ + {η}_{t} \qquad ( 31 )$$

Next, it is necessary to go from the time step t=T to t=0, and it is obvious that δ_{T}=0, at this time, it may be obtained

$$‖ {δ}_{0} ‖ \leq {\sum }_{t = 1}^{T} ( {\prod }_{k = 1}^{t - 1} {ρ}_{k} ) {η}_{t} \qquad ( 32 )$$

After substituting the noise residual term, the upper bound of the norm of the error transfer equation after adding the correction term is

$$‖ {δ}_{0} ‖ \leq σ {\sum }_{t = 1}^{T} ( {\prod }_{k = 1}^{t - 1} {ρ}_{k} ) \frac{1}{\sqrt{{α}_{t - 1}}} {\sum }_{k = t + 1}^{min ( t + m , T )} \sqrt{{α}_{k - 1}} ‖ {B}_{k} ‖ \qquad ( 33 )$$

The uncorrected error transfer equation is:

$${δ}_{t - 1}^{Original} = {A}_{t} {δ}_{t}^{Original} + {B}_{t} {ε}_{t} \qquad ( 34 )$$

The upper bound of the norm of the formula (34) is:

$$‖ {δ}_{0}^{Original} ‖ \leq σ {\sum }_{t = 1}^{T} ( {\prod }_{k = 1}^{t - 1} {ρ}_{k} ) ‖ {B}_{t} ‖ \qquad ( 35 )$$

Next, comparing the formula (33) and the formula (35), since the conversion information at is monotonically decreasing, and k≥t+1, the following formula may be obtained:

$$\frac{\sqrt{{α}_{k - 1}}}{\sqrt{{α}_{t - 1}}} \leq 1 \to \sqrt{{α}_{k - 1}} \leq \sqrt{{α}_{t - 1}} \qquad ( 36 )$$

$$\frac{1}{\sqrt{{α}_{t - 1}}} {\sum }_{k = t + 1}^{min ( t + m , T )} \sqrt{{α}_{k - 1}} ‖ {B}_{k} ‖ \leq {\sum }_{k = t + 1}^{min ( t + m , T )} ‖ {B}_{k} ‖ \qquad ( 37 )$$

$${\sum }_{k = t + 1}^{min ( t + m , T )} ‖ {B}_{k} ‖ \leq ‖ {B}_{t} ‖ \qquad ( 38 )$$

When m=1, the formula (38) holds, and ∥Bₜ₊₁∥≤∥Bₜ∥. The norm of the cumulative error satisfies the following formula:

$$‖ {δ}_{0} ‖ \leq σ {\sum }_{t = 1}^{T} ( {\prod }_{k = 1}^{t - 1} {ρ}_{k} ) ‖ {B}_{t} ‖ \leq ‖ {δ}_{0}^{Original} ‖ \qquad ( 39 )$$

In summary, the error compensation value corresponding to the first processing step may be determined based on the first processing step and the previous processing step of the first processing step.

In some embodiments, a plurality of sample inputs may be used to determine the single-step error information corresponding to a certain processing step. For example, different machine learning models may be used to process the plurality of sample inputs to determine the single-step error information corresponding to the different machine learning models. In some embodiments, for a certain machine learning model (for example, a diffusion model), a plurality of sample inputs may be provided to the unadjusted machine learning model to obtain the first sample outputs of the machine learning model corresponding to the plurality of sample inputs, respectively. At the same time, the plurality of sample inputs are provided to the machine learning model to which the adjustment has been applied, to obtain a plurality of second sample outputs of the machine learning model corresponding to the plurality of sample inputs, respectively. For example, for a certain machine learning model, before the model is deployed, the model is used to generate a plurality of first sample outputs based on the plurality of sample inputs. After the model is deployed, the model with the quantized parameters is used to generate a plurality of second sample outputs based on the plurality of sample inputs. Subsequently, the single-step error information is determined based on the difference between the plurality of first sample inputs and the plurality of second sample outputs.

In some embodiments, the single-step error information corresponding to different processing steps may be different. For example, for a certain processing step, the single-step error information corresponding to the processing step may be determined in the following manner. For a given first sample output of the plurality of first sample outputs, a given second sample output corresponding to the given first sample output is determined from the plurality of second sample outputs, the given first sample output and the given second sample output corresponding to the same sample input. A first processing result for the first processing step in the given first sample output and a second processing result for the first processing step in the given second sample output are determined. That is to say, the determined first processing result and the determined second processing result are the processing results generated by the adjusted machine learning model 130-2 and the unadjusted machine learning model 130-1 based on the same sample input in the same processing step in the data processing task. Subsequently, a sample error corresponding to the given first sample input is determined based on the difference between the first processing result and the second processing result. For example, the first processing result and the second processing result may be output images. A single-step error information item corresponding to the first processing step is determined based on a plurality of sample errors corresponding to the plurality of first sample inputs, respectively. In some embodiments, the single-step error information item corresponding to the first processing step may be determined based on the average value or the median of the plurality of sample errors.

Continuing to refer to FIG. 2, in some embodiments, the second model input for the processing steps of the plurality of processing steps may be determined based on the first model input, the first model output, and the error compensation value, as shown in the formula (1). In some embodiments, after obtaining the model output 144 of the machine learning model, the judgment unit 210 may be used to determine whether the current processing step is the final processing step. For example, if the machine learning model 130-2 is a diffusion model, it is determined whether the time step corresponding to the current processing step is t=0 or t=T. If the current processing step is the final processing step, the target output 220 of the data processing task may be determined based on the first model input, the first model output, and the error compensation value. If it is not the final processing step, the first model output determined in the first processing step is fed back to the machine learning model 130-2. For example, the second model input may be generated based on the first model input, the first model output, and the determined error compensation value corresponding to the first processing step. Subsequently, the second model input is provided to the machine learning model 130-2, and the machine learning model 130-2 is used again to perform the second processing step.

### Example Process

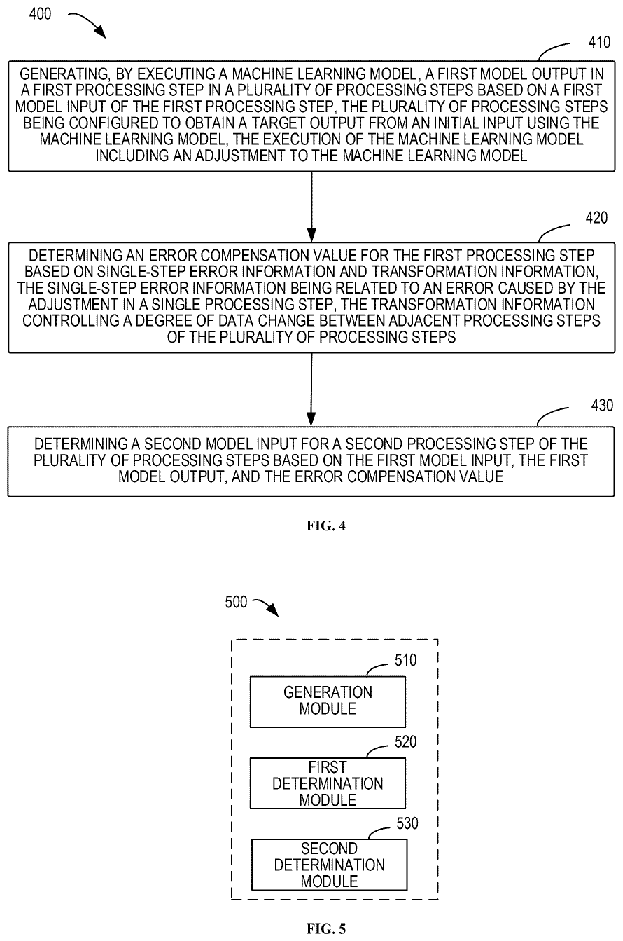

FIG. 4 illustrates a flowchart of an example process 400 of data processing according to some embodiments of the present disclosure. The process 400 may be implemented at the electronic device 150. The process 400 is described below with reference to FIG. 1.

As shown in FIG. 4, at the block 410, the electronic device 150 generates, by executing a machine learning model, a first model output in a first processing step of a plurality of processing steps based on a first model input of the first processing step, the plurality of processing steps being configured to obtain a target output from an initial input using the machine learning model, the execution of the machine learning model including an adjustment to the machine learning model.

In some embodiments, the model input of the machine learning model includes an input image, and the model output includes an output image.

In some embodiments, the adjustment includes quantization on a weight matrix of the machine learning model.

In some embodiments, the machine learning model is a denoising diffusion implicit model.

At the block 420, the electronic device 150 determines an error compensation value for the first processing step based on single-step error information and transformation information, the single-step error information being related to an error caused by the adjustment in a single processing step, the transformation information controlling a degree of data change between adjacent processing steps of the plurality of processing steps.

In some embodiments, the determining the error compensation value includes: determining, based on the transformation information, a plurality of transformation information items respectively corresponding to a plurality of previous processing steps of the second processing step; determining, based on the single-step error information, a plurality of single-step error items respectively corresponding to the plurality of previous processing steps; and determining the error compensation value based on the plurality of transformation information items and the plurality of single-step error items.

In some embodiments, the plurality of previous processing steps include the first processing step and a previous processing step of the first processing step.

In some embodiments, determining the error compensation value includes: determining a scaling factor based on a transformation information item corresponding to the first processing step in the transformation information; determining a plurality of weight coefficients based on the plurality of transformation information items, a weight coefficient of the plurality of weight coefficients indicating an influence degree of a corresponding processing step of the plurality of previous processing steps on the second processing step; determining a cumulative error value corresponding to the first processing step based on the plurality of weight coefficients and a plurality of single-step error items respectively corresponding to the plurality of previous processing steps; and determining the error compensation value based on the cumulative error value and the scaling factor.

In some embodiments, the single-step error information is determined by: providing a plurality of sample inputs to the machine learning model to which the adjustment is not applied, to obtain a plurality of first sample outputs of the machine learning model respectively corresponding to the plurality of sample inputs; providing the plurality of sample inputs to the machine learning model to which the adjustment is applied, to obtain a plurality of second sample outputs of the machine learning model respectively corresponding to the plurality of sample inputs; and determining the single-step error information based on the plurality of first sample outputs and the plurality of second sample outputs.

In some embodiments, the single-step error information includes a single-step error item corresponding to the first processing step, and the single-step error item corresponding to the first processing step is determined by: for a given first sample output of the plurality of first sample outputs, determining a given second sample output corresponding to the given first sample output from the plurality of second sample outputs, the given first sample output and the given second sample output corresponding to a same sample input; determining a first processing result for the first processing step in the given first sample output and a second processing result for the first processing step in the given second sample output; determining a sample error corresponding to the given first sample input based on a difference between the first processing result and the second processing result; and determining a single-step error information item corresponding to the first processing step based on a plurality of sample errors respectively corresponding to the plurality of first sample inputs.

At the block 430, the electronic device 150 determines a second model input for a second processing step of the plurality of processing steps based on the first model input, the first model output, and the error compensation value.

### Example Apparatus and Device

The embodiments of the present disclosure also provide the corresponding apparatus for implementing the above method or process. FIG. 5 is a schematic structural block diagram of an example apparatus 500 for data processing according to some embodiments of the present disclosure. The apparatus 500 may be implemented or included in the electronic device 150. Each module/component in the apparatus 500 may be implemented by hardware, software, firmware, or any combination thereof.

As shown in FIG. 5, the apparatus 500 includes a generation module 510 configured to generate, by executing a machine learning model, a first model output in a first processing step of a plurality of processing steps based on a first model input of the first processing step, the plurality of processing steps being configured to obtain a target output from an initial input using the machine learning model, the execution of the machine learning model including an adjustment to the machine learning model. The apparatus 500 further includes a first determination module 520 configured to determine an error compensation value for the first processing step based on single-step error information and transformation information, the single-step error information being related to an error caused by the adjustment in a single processing step, the transformation information controlling a degree of data change between adjacent processing steps of the plurality of processing steps. The apparatus 500 further includes a second determination module 530 configured to determine a second model input for a second processing step of the plurality of processing steps based on the first model input, the first model output, and the error compensation value.

In some embodiments, the model input of the machine learning model includes an input image, and the model output includes an output image.

In some embodiments, the adjustment includes quantization on a weight matrix of the machine learning model.

In some embodiments, the machine learning model is a denoising diffusion implicit model.

In some embodiments, the first determination module 520 is further configured to determine, based on the transformation information, a plurality of transformation information items respectively corresponding to a plurality of previous processing steps of the second processing step; determining, based on the single-step error information, a plurality of single-step error items respectively corresponding to the plurality of previous processing steps; and determining the error compensation value based on the plurality of transformation information items and the plurality of single-step error items.

In some embodiments, the plurality of previous processing steps include the first processing step and a previous processing step of the first processing step.

In some embodiments, the first determination module 520 is further configured to determine a scaling factor based on a transformation information item corresponding to the first processing step in the transformation information; determining a plurality of weight coefficients based on the plurality of transformation information items, a weight coefficient of the plurality of weight coefficients indicating an influence degree of a corresponding processing step of the plurality of previous processing steps on the second processing step; determining a cumulative error value corresponding to the first processing step based on the plurality of weight coefficients and a plurality of single-step error items respectively corresponding to the plurality of previous processing steps; and determining the error compensation value based on the cumulative error value and the scaling factor.

In some embodiments, the first determination module 520 is further configured to provide a plurality of sample inputs to the machine learning model to which the adjustment is not applied, to obtain a plurality of first sample outputs of the machine learning model respectively corresponding to the plurality of sample inputs; providing the plurality of sample inputs to the machine learning model to which the adjustment is applied, to obtain a plurality of second sample outputs of the machine learning model respectively corresponding to the plurality of sample inputs; and determining the single-step error information based on the plurality of first sample outputs and the plurality of second sample outputs.

In some embodiments, the single-step error information includes a single-step error item corresponding to the first processing step, and the first determination module 520 is further configured to, for a given first sample output of the plurality of first sample outputs, determine a given second sample output corresponding to the given first sample output from the plurality of second sample outputs, the given first sample output and the given second sample output corresponding to a same sample input; determining a first processing result for the first processing step in the given first sample output and a second processing result for the first processing step in the given second sample output; determining a sample error corresponding to the given first sample input based on a difference between the first processing result and the second processing result; and determining a single-step error information item corresponding to the first processing step based on a plurality of sample errors respectively corresponding to the plurality of first sample inputs.

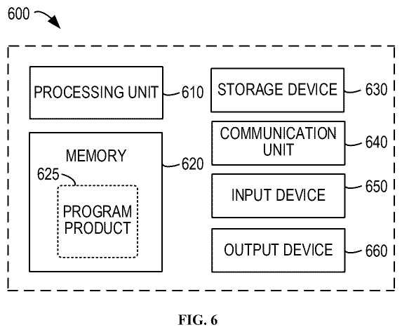

FIG. 6 is a block diagram of an electronic device 600 capable of implementing a plurality of embodiments of the present disclosure. As shown in FIG. 6, the electronic device 600 is in the form of a general electronic device. The components of the electronic device 600 may include, but are not limited to, one or more processors or processing units 610, a memory 620, a storage device 630, one or more communication units 640, one or more input devices 650, and one or more output devices 660. The processing unit 610 may be an actual or virtual processor and may execute various processes based on the programs stored in the memory 620. In a multi-processor system, a plurality of processing units execute computer executable instructions in parallel to improve the parallel processing capability of the electronic device 600.

The electronic device 600 typically includes a plurality of computer storage medium. Such medium may be any available medium accessible by the electronic device 600, including but not limited to volatile and non-volatile medium, removable and non-removable medium. The memory 620 may be a volatile memory (for example, a register, cache, a random access memory (RAM)), a non-volatile memory (such as a read-only memory (ROM), an electrically erasable programmable read-only memory (EEPROM), a flash memory), or any combination thereof. The storage device 630 may be any removable or non-removable medium, and may include a machine-readable medium such as a flash drive, a disk, or any other medium, which may be used to store information and/or data and may be accessed within the electronic device 600.

The electronic device 600 may further include additional removable/non-removable, volatile/non-volatile memory medium. Although not shown in FIG. 6, a disk driver for reading from or writing to a removable, non-volatile disk (such as a “floppy disk”), and an optical disk driver for reading from or writing to a removable, non-volatile optical disk may be provided. In these cases, each driver may be connected to the bus (not shown) by one or more data medium interfaces. The memory 620 may include a computer program product 625, which has one or more program modules configured to perform various methods or acts of the various embodiments of the present disclosure.

The communication unit 640 implements communication with other electronic devices through the communication medium. Additionally, the functions of the components of the electronic device 600 may be implemented by a single computing cluster or a plurality of computing machines, which may communicate through communication connections. Therefore, the electronic device 600 may use the logical connection with one or more other servers, a network personal computer (PC) or another network node to operate in a networked environment.

The input device 650 may be one or more input devices, such as a mouse, a keyboard, a tracking ball, etc. The output device 660 may be one or more output devices, such as a display, a speaker, a printer, etc. The electronic device 600 may also communicate with one or more external devices (not shown) through the communication unit 640 as needed, the external devices such as a storage device, a display device, etc., communicate with one or more devices that enable the user to interact with the electronic device 600, or communicate with any devices (such as a network card, a modem, etc.) that enable the electronic device 600 to communicate with one or more other electronic devices. Such communication may be performed via input/output (I/O) interfaces (not shown).

According to an example implementation of the present disclosure, there is provided a computer-readable storage medium having computer-executable instructions stored thereon, where the computer-executable instructions are executed by a processor to implement the method described above. According to an example implementation of the present disclosure, there is further provided a computer program product tangibly stored on a non-transitory computer-readable medium and including computer-executable instructions, where the computer-executable instructions are executed by a processor to implement the method described above.

Various aspects of the present disclosure are described herein with reference to the flowcharts and/or block diagrams of the method, apparatus, device and computer program product implemented according to the present disclosure. It may be understood that each block of the flowcharts and/or block diagrams, and combinations of blocks in the flowcharts and/or block diagrams, may be implemented by computer-readable program instructions.

These computer-readable program instructions may be provided to the processing unit of a general-purpose computer, a special-purpose computer, or other programmable data processing apparatus to produce a machine, such that when these instructions are executed by the processing unit of a computer or other programmable data processing apparatus, an apparatus for implementing the functions/actions specified in one or more blocks of the flowcharts and/or block diagrams is produced. These computer-readable program instructions may also be stored in a computer-readable storage medium, and these instructions cause a computer, a programmable data processing apparatus, and/or other devices to work in a specific manner, so that the computer-readable medium storing the instructions includes a manufactured product, which includes instructions for implementing various aspects of the functions/actions specified in one or more blocks of the flowcharts and/or block diagrams.

The computer-readable program instructions may be loaded onto a computer, another programmable data processing apparatus, or other devices, so that a series of operation steps are performed on the computer, the other programmable data processing apparatus, or the other devices to generate a computer-implemented process, so that the instructions executed on the computer, the other programmable data processing apparatus, or the other devices implement the functions/actions specified in one or more blocks of the flowcharts and/or block diagrams.

The flowchart and block diagrams in the drawings show the possibly implemented architectures, functions, and operations of the system, method and computer program product according to a plurality of implementations of the present disclosure. In this regard, each block in the flowchart or block diagrams may represent a module, a program segment, or a part of instructions, and the module, the program segment, or the part of instructions contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It would also be noted that each block in the block diagrams and/or flowcharts, and combinations of blocks in the block diagrams and/or flowcharts, may be implemented by a special-purpose hardware-based system that perform the specified functions or actions, or may be implemented by a combination of special-purpose hardware and computer instructions.

The implementations of the present disclosure have been described above, and the above description is illustrative, non-exhaustive, and not limited to the disclosed implementations. Without departing from the scope of the illustrated implementations, many modifications and variations will be apparent to those of ordinary skill in the art. The terms used herein are chosen to best explain the principles of the implementations, the practical applications, or improvements to the technologies in the market, or to enable other those of ordinary skill in the art to understand the implementations disclosed herein.

1. A data processing method, comprising:
generating, by executing a machine learning model, a first model output in a first processing step of a plurality of processing steps based on a first model input of the first processing step, the plurality of processing steps being configured to obtain an output from an input using the machine learning model, the execution of the machine learning model comprising an adjustment to the machine learning model;
determining an error compensation value for the first processing step based on single-step error information and transformation information, the single-step error information being related to an error caused by the adjustment in a single processing step, the transformation information controlling a degree of data change between adjacent processing steps of the plurality of processing steps; and
determining a second model input for a second processing step of the plurality of processing steps based on the first model input, the first model output, and the error compensation value.

2. The method of claim 1, wherein determining the error compensation value comprises:
determining, based on the transformation information, a plurality of transformation information items respectively corresponding to a plurality of previous processing steps of the second processing step; and
determining, based on the single-step error information, a plurality of single-step error items respectively corresponding to the plurality of previous processing steps; and
determining the error compensation value based on the plurality of transformation information items and the plurality of single-step error items.

3. The method of claim 2, wherein the plurality of previous processing steps comprise the first processing step and a previous processing step of the first processing step.

4. The method of claim 2, wherein determining the error compensation value comprises:
determining a scaling factor based on a transformation information item, in the transformation information, corresponding to the first processing step;
determining a plurality of weight coefficients based on the plurality of transformation information items, a weight coefficient of the plurality of weight coefficients indicating an influence degree of a corresponding processing step of the plurality of previous processing steps on the second processing step;
determining a cumulative error value corresponding to the first processing step based on the plurality of weight coefficients and a plurality of single-step error items respectively corresponding to the plurality of previous processing steps; and
determining the error compensation value based on the cumulative error value and the scaling factor.

5. The method of claim 1, wherein the single-step error information is determined by:
providing a plurality of sample inputs to the machine learning model without the adjustment being applied, to obtain a plurality of first sample outputs, by the machine learning model, respectively corresponding to the plurality of sample inputs;
providing the plurality of sample inputs to the machine learning model with the adjustment being applied, to obtain a plurality of second sample outputs, by the machine learning model, respectively corresponding to the plurality of sample inputs; and
determining the single-step error information based on the plurality of first sample outputs and the plurality of second sample outputs.

6. The method of claim 5, wherein the single-step error information comprises a single-step error item corresponding to the first processing step, and the single-step error item corresponding to the first processing step is determined by:
for a given first sample output of the plurality of first sample outputs,
determining a given second sample output corresponding to the given first sample output from the plurality of second sample outputs, the given first sample output and the given second sample output corresponding to a same sample input;
determining a first processing result for the first processing step in the given first sample output and a second processing result for the first processing step in the given second sample output;
determining a sample error corresponding to the given first sample input based on a difference between the first processing result and the second processing result; and
determining the single-step error information item corresponding to the first processing step based on a plurality of sample errors respectively corresponding to the plurality of first sample inputs.

7. The method of claim 4, wherein the plurality of weight coefficients is determined based on transformation information items corresponding to respective processing steps.

8. The method of claim 1, wherein a model input of the machine learning model comprises an input image, and the model output comprises an output image.

9. The method of claim 1, wherein the adjustment comprises quantization on a weight matrix of the machine learning model.

10. The method of claim 1, wherein the machine learning model is a denoising diffusion implicit model.

11. An electronic device, comprising:
at least one processing unit; and
at least one memory coupled to the at least one processing unit and storing instructions for execution by the at least one processing unit, the instructions, when executed by the at least one processing unit, causing the electronic device to perform acts comprising:
generating, by executing a machine learning model, a first model output in a first processing step of a plurality of processing steps based on a first model input of the first processing step, the plurality of processing steps being configured to obtain an output from an input using the machine learning model, the execution of the machine learning model comprising an adjustment to the machine learning model;
determining an error compensation value for the first processing step based on single-step error information and transformation information, the single-step error information being related to an error caused by the adjustment in a single processing step, the transformation information controlling a degree of data change between adjacent processing steps of the plurality of processing steps; and
determining a second model input for a second processing step of the plurality of processing steps based on the first model input, the first model output, and the error compensation value.

12. A non-transitory computer-readable storage medium having a computer program stored thereon, the computer program being executable by a processor to implement acts comprising:
generating, by executing a machine learning model, a first model output in a first processing step of a plurality of processing steps based on a first model input of the first processing step, the plurality of processing steps being configured to obtain an output from an input using the machine learning model, the execution of the machine learning model comprising an adjustment to the machine learning model;
determining an error compensation value for the first processing step based on single-step error information and transformation information, the single-step error information being related to an error caused by the adjustment in a single processing step, the transformation information controlling a degree of data change between adjacent processing steps of the plurality of processing steps; and
determining a second model input for a second processing step of the plurality of processing steps based on the first model input, the first model output, and the error compensation value.

13. The non-transitory computer-readable storage medium of claim 12, wherein determining the error compensation value comprises:
determining, based on the transformation information, a plurality of transformation information items respectively corresponding to a plurality of previous processing steps of the second processing step; and
determining, based on the single-step error information, a plurality of single-step error items respectively corresponding to the plurality of previous processing steps; and
determining the error compensation value based on the plurality of transformation information items and the plurality of single-step error items.

14. The non-transitory computer-readable storage medium of claim 13, wherein the plurality of previous processing steps comprise the first processing step and a previous processing step of the first processing step.

15. The non-transitory computer-readable storage medium of claim 13, wherein determining the error compensation value comprises:
determining a scaling factor based on a transformation information item, in the transformation information, corresponding to the first processing step;
determining a plurality of weight coefficients based on the plurality of transformation information items, a weight coefficient of the plurality of weight coefficients indicating an influence degree of a corresponding processing step of the plurality of previous processing steps on the second processing step;
determining a cumulative error value corresponding to the first processing step based on the plurality of weight coefficients and a plurality of single-step error items respectively corresponding to the plurality of previous processing steps; and
determining the error compensation value based on the cumulative error value and the scaling factor.

16. The non-transitory computer-readable storage medium of claim 12, wherein the single-step error information is determined by:
providing a plurality of sample inputs to the machine learning model without the adjustment being applied, to obtain a plurality of first sample outputs, by the machine learning model, respectively corresponding to the plurality of sample inputs;
providing the plurality of sample inputs to the machine learning model with the adjustment being applied, to obtain a plurality of second sample outputs, by the machine learning model, respectively corresponding to the plurality of sample inputs; and
determining the single-step error information based on the plurality of first sample outputs and the plurality of second sample outputs.

17. The non-transitory computer-readable storage medium of claim 16, wherein the single-step error information comprises a single-step error item corresponding to the first processing step, and the single-step error item corresponding to the first processing step is determined by:
for a given first sample output of the plurality of first sample outputs,
determining a given second sample output corresponding to the given first sample output from the plurality of second sample outputs, the given first sample output and the given second sample output corresponding to a same sample input;
determining a first processing result for the first processing step in the given first sample output and a second processing result for the first processing step in the given second sample output;
determining a sample error corresponding to the given first sample input based on a difference between the first processing result and the second processing result; and
determining the single-step error information item corresponding to the first processing step based on a plurality of sample errors respectively corresponding to the plurality of first sample inputs.

18. The non-transitory computer-readable storage medium of claim 16, wherein the plurality of weight coefficients is determined based on transformation information items corresponding to respective processing steps.

19. The non-transitory computer-readable storage medium of claim 12, wherein a model input of the machine learning model comprises an input image, and the model output comprises an output image.

20. The non-transitory computer-readable storage medium of claim 12, wherein the adjustment comprises quantization on a weight matrix of the machine learning model.
